(19) United States
(12) Patent Application Publication
(10) Pub. No.: US 2025/0343501 A1
(43) Pub. Date: Nov. 6, 2025

(54) SOLAR TABLE BUFFER

(71) Applicant: Terabase Energy, Inc., Berkeley, CA (US)

(72) Inventors: Dylan Harper, Vancouver, WA (US); Johann Fritz Karkheck, Petaluma, CA (US)

(73) Assignee: Terabase Energy, Inc., Berkeley, CA (US)

(21) Appl. No.: 18/655,630

(22) Filed: May 6, 2024

(51) Int. Cl. H02S 20/32; F24S 30/00; F24S 30/425; H02S 30/10

(52) U.S. Cl. CPC H02S 20/32; F24S 30/425; H02S 30/10; F24S 2030/12

(57) ABSTRACT

System and method embodiments of off-loading completed solar tables from the assembly area for improved assembling efficiency are disclosed. An assembly and off-loading system may comprise an assembly stage for solar table assembling, a table buffer section, and a table off-loading section. The table buffer section is an extra section of conveyance and support to allow assembled solar tables to move out of the assembly area from the path of incoming torque tubes. The table off-loading section is where the assembled solar table is off-loaded onto a mobile transport. The table buffer section decouples the table assembly process from table off-loading, thus eliminating potential interference/blocking by table off-loading or mobile transport parking to subsequent table assembly processes. Consequently, the assembly of subsequent solar tables may be carried out without interruption or interference, and overall assembly efficiency increases.

### TECHNICAL FIELD

The present disclosure relates generally to solar table assembly. More particularly, the present disclosure relates to systems and methods of off-loading completed solar tables from assembly area for improved assembling efficiency.

### BACKGROUND

The importance of solar power systems is well understood by one of skill in the art. Government agencies and companies are scaling the size and number of solar solutions within their energy infrastructure. This transition from traditional fossil fuel energy systems to solar energy solutions presents several challenges. One challenge is the cost-effective management of the construction process and the ability to move components around the site efficiently during the construction process.

FIG. 1 shows a typical solar farm 105 comprising an array of installed solar structures 110. Each solar structure comprises multiple solar panels 115. In a typical installation process, multiple solar panels are securely aligned and attached to a metal structure (e.g., purlins or torque tube) to form a row of solar panels. A solar farm may comprise one or more solar arrays, each with hundreds of rows of solar panels. A row of solar panels may be supported by supporting structures (e.g., ground piles, ground screws, ballasted foundations, etc.) with the metal structure securely fastened to supporting structures at a desired rotational angle such that the solar panels are oriented for maximum energy production efficiency.

Large-scale solar panel systems typically include thousands of solar panels located across a multi-acre terrain and electrically coupled to provide a source of energy. These large-scale systems are often located in remote areas and require a significant investment in materials, resources, and labor for installation and design. The sourcing and delivery of materials and resources for these installations can be problematic and inconsistent. A further complication is the reliable and safe movement of these materials and resources across large areas of the construction site and maintaining consistent installation processes at each point of installation within the site. These issues further contribute to an increase in the cost and complexity of a very cost-sensitive process.

What is needed are systems and methods that can effectively improve installation efficiency to facilitate large solar projects.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that the description is not intended to limit the scope of the invention to these particular embodiments. Items in the figures may be not to scale.

FIG. 1 depicts a general layout of a large-scale solar site.

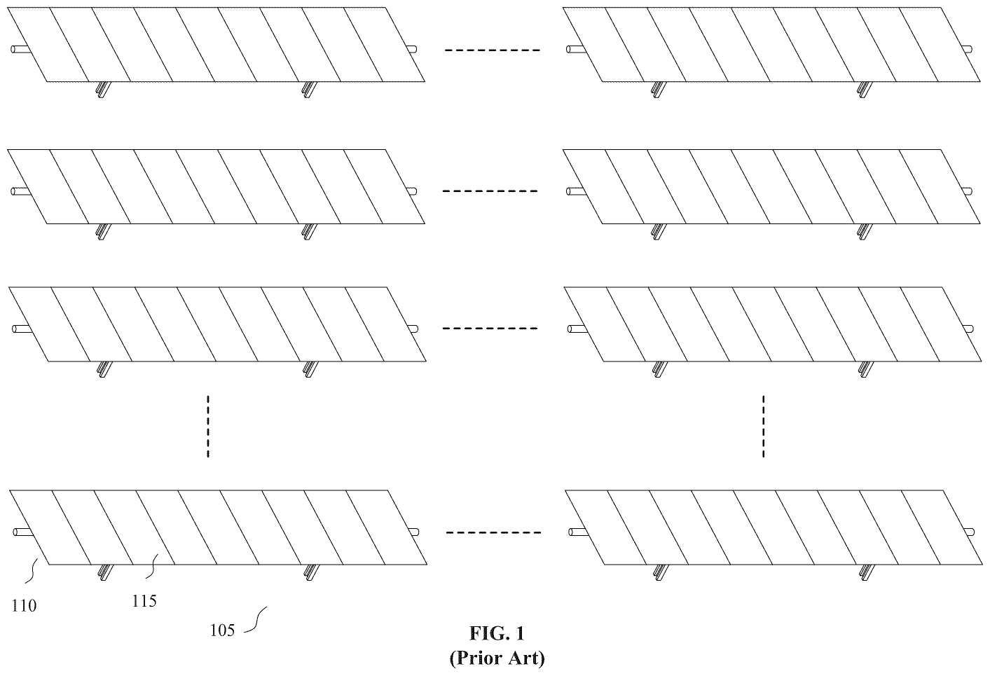

FIG. 2 depicts a centralized solar table assembly and installation for large-scale solar systems according to various embodiments of the invention.

FIG. 3 depicts a process layout for solar table assembling and off-loading according to various embodiments of the invention.

FIG. 4 depicts an assembly framework on which solar panels are loaded so that a solar table may be created according to various embodiments of the invention.

FIG. 5 depicts a backside view of an assembly station according to various embodiments of the invention.

FIG. 6 depicts a close-up view of a torque tube roller according to various embodiments of the invention.

FIG. 7 depicts a standalone view of a torque tube controller according to various embodiments of the invention.

FIG. 8 is a perspective view of the table buffer section according to various embodiments of the present invention.

FIG. 9 is a close-up view of a lower rail in the table buffer section according to various embodiments of the present invention.

FIG. 10 depicts a standalone view of an off-loading lift according to various embodiments of the invention.

FIG. 11 depicts a perspective view of an off-loading lift with a solar table according to various embodiments of the invention.

FIG. 12 depicts handoff of a solar table from off-loading lifts to loading lifts according to various embodiments of the invention.

FIG. 13 is a process diagram of off-loading a solar table from an assembly stage according to various embodiments of the invention.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method.

Components, or features, shown in diagrams are illustrative of exemplary embodiments of the invention and are meant to avoid obscuring the invention. It shall also be understood that throughout this discussion, components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in a variety of mechanical structures supporting corresponding functionalities of the solar table mobile transport.

Furthermore, connectivity between components or systems within the figures is not intended to be limited to direct connections. Also, components may be integrated together or be discrete prior to the construction of a solar panel mobile transport.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A component, function, or structure is not limited to a single component, function, or structure; usage of these terms may refer to a grouping of related components, functions, or structures, which may be integrated and/or discrete.

Further, it shall be noted that: (1) certain components or functions may be optional; (2) components or functions may not be limited to the specific description set forth herein; (3) certain components or functions may be assembled/combined differently across different solar table mobile transports; and (4) certain functions may be performed concurrently or in sequence.

In this document, “large-scale solar system” refers to a solar system having a thousand or more solar panels. The word “resources” refers to material, parts, components, equipment or any other items used to construct a solar assembly and/or solar system. The word “personnel” refers to any laborer, worker, designer or individual employed to construct or design a solar table or solar system. The term “solar table” refers to a structural assembly comprising a torque tube and/or purlins with module rails. Some types of solar tables may have supplemental structure that allows it to connect to foundations/piles while other types do not have this supplemental structure.

Traditional installation process for solar systems is implemented such that all mounting equipment for each solar panel is individually assembled and installed at its location within the larger system. Such traditional deployment relies on materials being delivered to a deployment site via an access road. The materials are then processed and staged at the deployment site by a crew. The cost-effectiveness of this approach works fine within smaller solar deployments but struggles to cost-effectively scale to large solar systems.

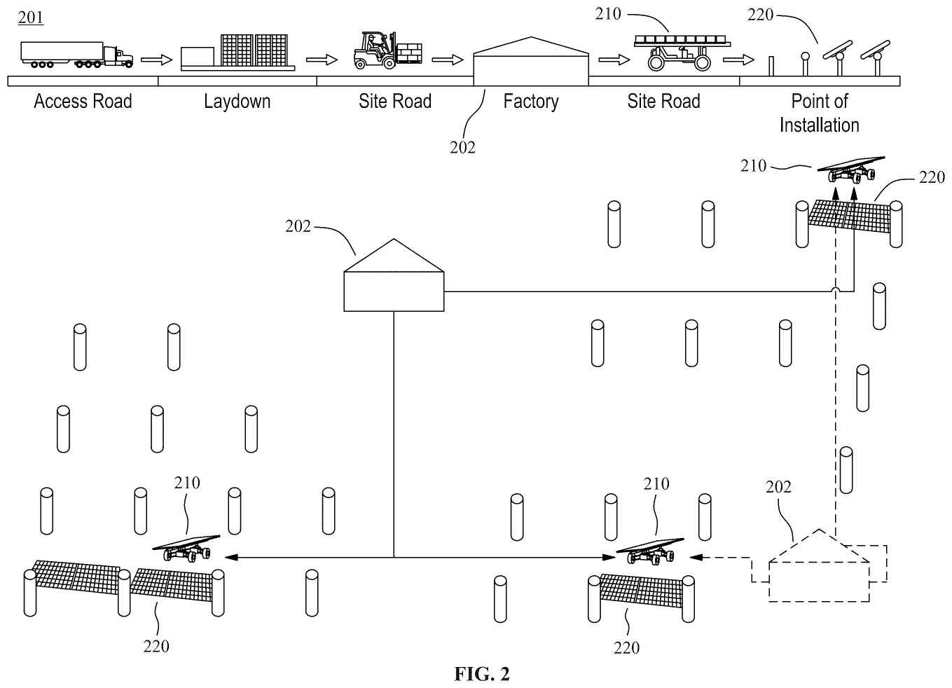

FIG. 2 provides an overview of a centralized solar table assembly and installation for large-scale solar systems according to various embodiments of the invention. Embodiments of the invention transition the traditional approach of distributed assembly and installation at single location sites to a centralized and coordinated assembly factory that allows a more cost-effective and dynamic process of constructing large-scale solar systems. This centralized assembly of solar system components, such as solar tables, necessitates a more robust transport vehicle to move the preassembled components to the installation site.

Resources are brought to construction site 201 for a large-scale solar system and initially processed. These resources are delivered to one or more assembly factories 202 where a coordinated and centralized solar table assembly process is performed. In certain embodiments, a construction site may have multiple centralized factories 202. The location and number of centralized factories 202 may depend on several parameters, including the size of the site, the terrain of the site, the design of the site, and other variables that relate to the construction of the large-scale solar system. Solar tables may be preassembled at a centralized factory 202 and to a point of installation 220 via motorized vehicles 210.

A centralized factory may need to provide preassembled solar tables to multiple motorized vehicles to support multiple points of installation. Given size and cost restrictions, a centralized factory may only be capable of operating one solar table assembly line. Therefore, it is important that solar tables are assembled efficiently at the centralized factory and cleared from the assembly line once they are assembled. Described hereinafter are solar table buffer embodiments that may be implemented to clear an assembled solar table from the assembly line after assembly completion, thus allowing the next set of modules to be loaded promptly for improved efficiency.

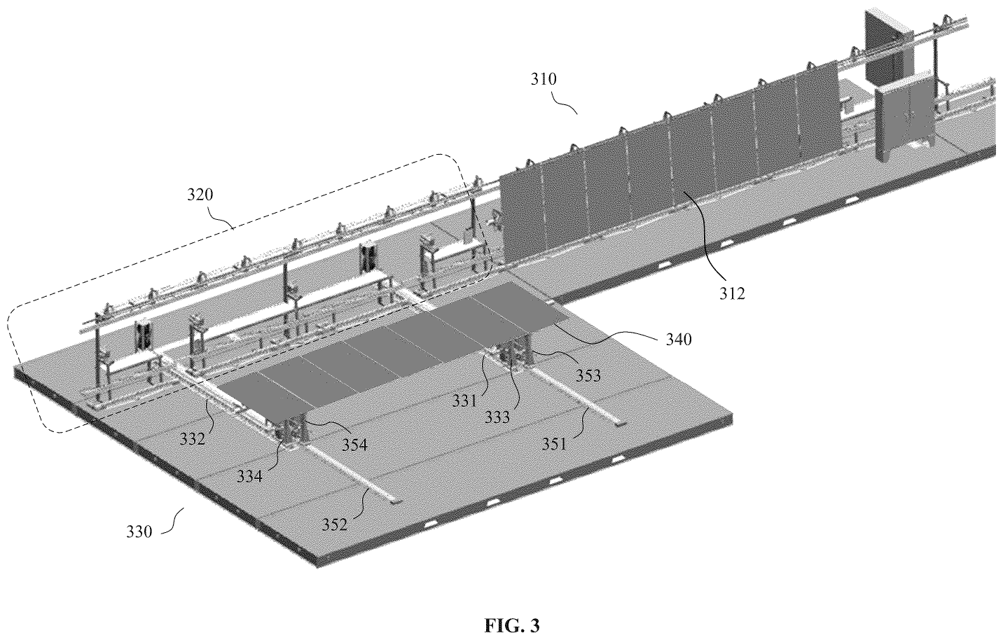

FIG. 3 depicts a process layout for solar table assembling and off-loading according to various embodiments of the invention. The process layout comprises an assembly stage 310 for solar table assembling, a table buffer section 320, and a table off-loading section 330. The assembly stage 310 is a section where separate components, e.g., solar panels, torque tube, coupling elements, etc., are assembled for a solar table 312 that can be loaded onto a mobile transport for installation. Table buffer section 320 is an extra section of conveyance and support to allow assembled solar tables to move out of the assembly area from the path of incoming torque tubes. The table off-loading section 330 is where the assembled solar table is off-loaded onto a mobile transport for stacking or installation directly.

In one or more embodiments, conveyor belts and module supports in the assembly stage 310 may be extended past the assembly stage such that an assembled solar table may be moved down to the table buffer section. Compared to traditional off-loading of assembled tables directly at the assembly stage, the table buffer section 320, located downstream of the assembling stage, decouples the table assembly process from table off-loading, thus eliminating potential interference/blocking by table off-loading or mobile transport parking to subsequent table assembly processes. Consequently, the assembly of subsequent solar tables may be carried out without interruption or interference, and overall assembly efficiency increases.

The table off-loading section 330 is placed in front of the table buffer section 320 to receive a solar table 340. As shown in FIG. 3, off-loading of the solar table 340 and assembling of the solar table 312 may be implemented in parallel for improved assembling and distributing efficiency. The table off-loading section 330 comprises a first off-loading rail 331, a first off-loading lift 333 slidably coupled to the first off-loading rail 331, a second off-loading rail 332, and a second off-loading lift 334 slidably coupled to the second off-loading rail 332. The first off-loading lift 333 and the second off-loading lift 334 receive the solar table 340 from the table buffer section 320 and move the solar table 340 to a desired position for off-loading the solar table onto a mobile transport directly or onto a pair of loading lifts 353/354.

As shown in FIG. 3, the first loading lift 353 is slidably coupled to a first loading rail 351, which offsets to the first off-loading rail 331. In other words, the first loading rail 351 has a starting position next to the ending position of the first off-loading rail 331. The second loader lift 354 is slidably coupled to a second loading rail 352, which offsets to the second off-loading rail 332. In other words, the second loading rail 352 has a starting position next to the ending position of the second off-loading rail 332. The loading lifts 353/354 slide to starting positions of the loading rails 351/352 to pick up the assembled solar table 340 from the off-loading lifts 333/334. Such a process with two separate transfer systems (off-loading lifts and loading lifts) may minimize the time that the buffer section 320 is blocked, since the off-loading lifts 333/334 may quickly off-load the table to the loader lifts and return behind the buffer section to allow a subsequent assembled solar table to be transferred to the buffer section 320. The off-loading lifts 333/334 need to return behind the buffer section 320 before the next assembled table can be off-loaded from the assembly area such that the off-loading lifts 333/334 are able to grab the torque tube from the back side. Additionally, the two systems of lifts provide two buffers for better prevention of assembled table blockage at the assembly stage 310.

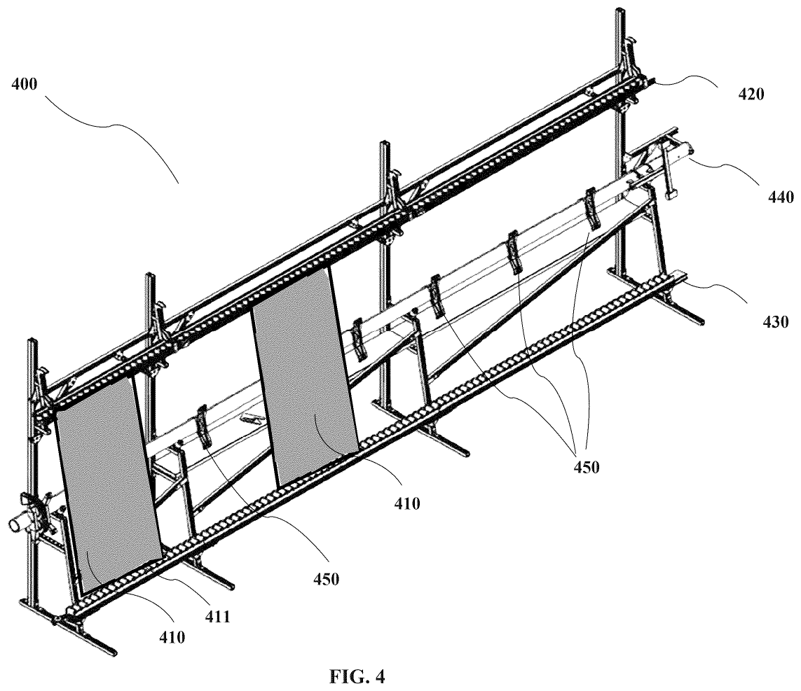

FIG. 4 illustrates an assembly framework on which solar panels are loaded so that a solar table may be assembled according to various embodiments of the invention. This figure illustrates one scenario in which the orientation of each solar panel positioned on the rails of the framework is important to the functioning of autonomous processes used in constructing the solar table. As shown, the assembly framework 400 comprises a top rail 420 and a bottom rail 430, each with rollers that allow solar panels 410 to move across the framework. In other embodiments, only one of the rails may have rollers. In yet other embodiments, other mechanisms known to one skilled in the art may be used instead of rollers. The assembly framework 400 also supports a torque tube 440 having multiple coupling elements 450 that secures the torque tube 440 to each of the solar panels 410.

In this example, solar panels 410 are loaded onto the framework 400 with a front-side facing outward and a bottom edge (or module rails 411) resting on the bottom rail 430 and a top edge being supported by the top rail 420. Each solar panel can move horizontally across the framework to properly position it relative to a torque tube 440 and/or coupling element 450. After being properly positioned, an individual or autonomous process secures the coupling element 450 to the backside of the solar panel 410. The coupling element 450 may be secured to solar panel 410 using screws and bolts, or rivets or other types of fasteners that are inserted into a rail(s) on the backside of the solar panel 410. One skilled in the art will recognize that this is one example of an assembly process and that other examples are supported by other embodiments of the example.

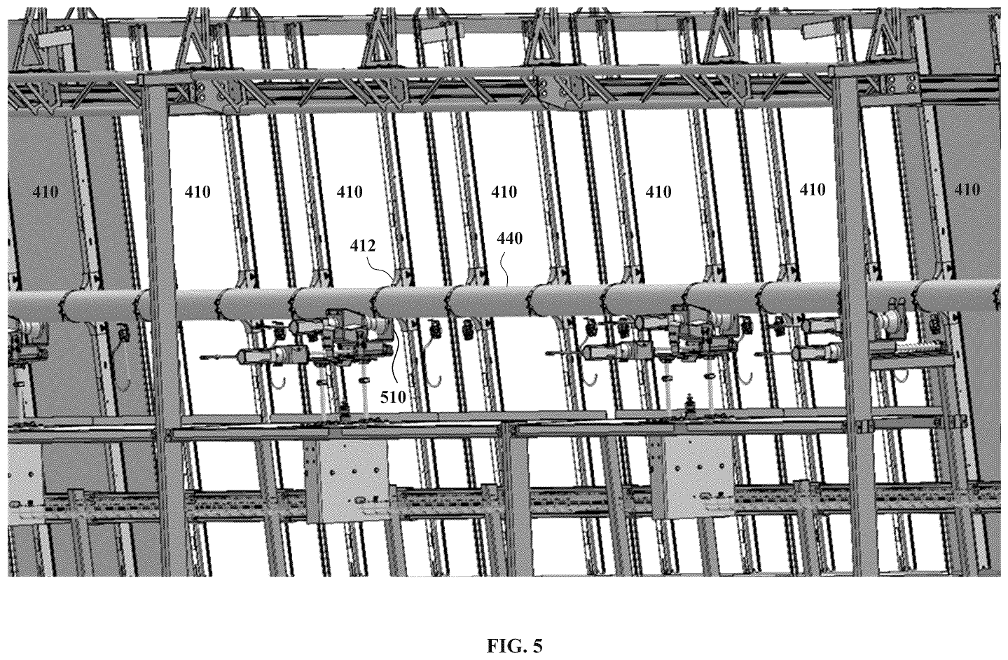

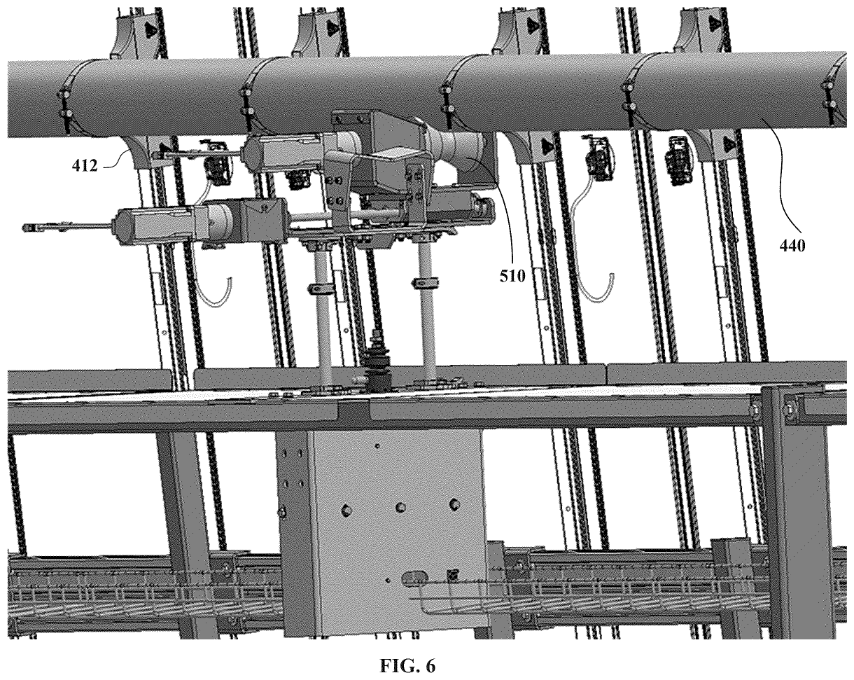

FIG. 5 depicts a backside view of an assembly station and FIG. 6 depicts a close-up view of a roller according to various embodiments of the invention. For a clear structural view of the assembly station, some solar panels 410 attached to the torque tube 440 are made transparent. The torque tube 440 is supported on a plurality of rollers 510, each of which is mounted on sliders of a roller controller to allow tube movement along the assembly station or to facilitate tube ejection when the torque tube has defects, e.g., cracks, distortion, etc. The rollers may be actuated both vertically and horizontally to facilitate the movement from the assembly stage 310 to the buffer stage 320. The rollers 510 may be initially positioned in a retracted position (further away from the solar panels 410) while the module attachment brackets 412 are attached. In the retracted position, the modules or panels are allowed to move freely along the conveyer without interfering with operation of attaching the brackets to the toque tube. After the solar panels have been attached to the torque tube, the rollers 510 are shifted down to provide physical clearance for the assembled solar table to be conveyed out to the buffer stage.

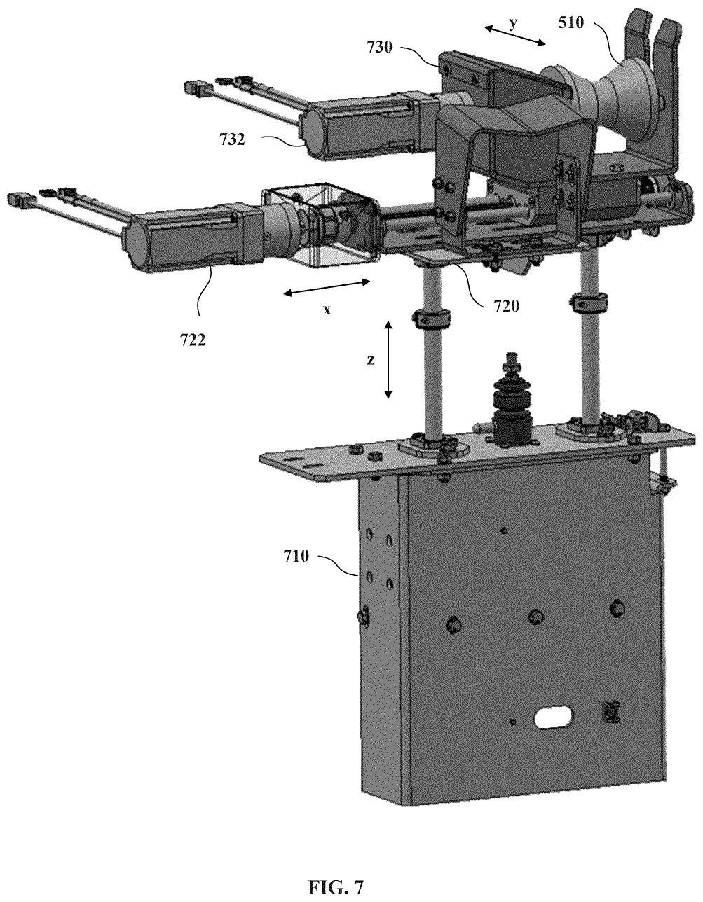

FIG. 7 depicts a standalone view of a torque tube controller according to various embodiments of the invention. The torque tube controller comprises a controller base 710, a horizontal slider 720, and a roller holder 730 attached to the horizontal slider 720. The controller base 710 allows vertical movement (z-direction) for the horizontal slider 720, which enables horizontal movement (x-direction) for the roller holder 730 via a sliding motor 722. The roller holder 730 has a roller motor to enable roller rotation for torque tube movement along the assembly station in the y-direction. Movement in each direction may be enabled independently or in collaboration for desired roller control.

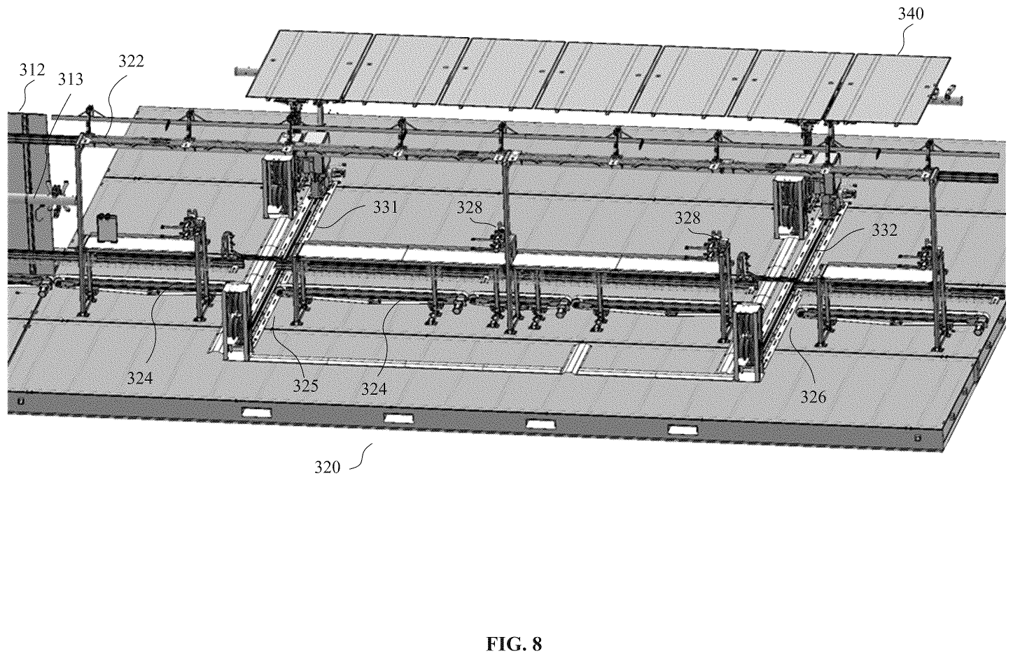

FIG. 8 is a perspective view of the table buffer section according to various embodiments of the present invention. The solar table 312, upon completion of assembly, is moved from the assembly stage 310 to the table buffer section 320. As shown in FIG. 8 and also FIG. 3, the table buffer section 320 comprises an upper rail 322 extending from the top rail 420 of the assembly stage 310 and a lower rail (or a lower conveyor) 324 extending from the bottom rail 430 of the assembly stage 310. In one or more embodiments, the upper rail 322 is continuous, while the lower rail 324 has a first gap 325 and a second gap 326 for the first off-loading rail 331 and the second off-loading rail 332, respectively. The gaps 325/326 allow pathways for the off-loading lifts 333/334 to slide behind the solar table 312 such that the off-loading lifts may slide across the gaps to a loading location to hold the torque tube 313 of the solar table when the solar table 312 is moved to the table buffer section 320. The loading location may be a start location of the off-loading rails 331/332. The gaps 325/326 have openings much less than a length of the fully assembled solar table 312. Therefore, the lower rail 324 is able to support the solar table 312 when the table is moved from the assembly stage 310 to the table buffer section 320.

The table buffer section 320 comprises multiple rollers 328, which are spaced and aligned to support and transfer a torque tube from a tube loading zone to the assembly stage 310 via the table buffer section 320. The tube loading zone and the assembly stage 310 are placed on opposite sides of the table buffer section 320 such that operation at the assembly stage 310 is subject to interference from tube tube loading. The rollers 328 may be adjusted horizontally and rotationally to receive a torque tube from a tube loading zone and move the torque tube to the assembly stage 310 when the plurality of rollers 510 are in the retracted position and aligned for receiving the torque tube from the table buffer section 320. In other words, the table buffer section 320 may serve a dual purpose of receiving an assembled solat table from the assembly stage 310 for offloading, and transferring a torque tube from the tube loading zone for solar table assembling. Such a dual function further improves solar table assembling efficiency and avoids inference between torque tube loading and solar table assembling.

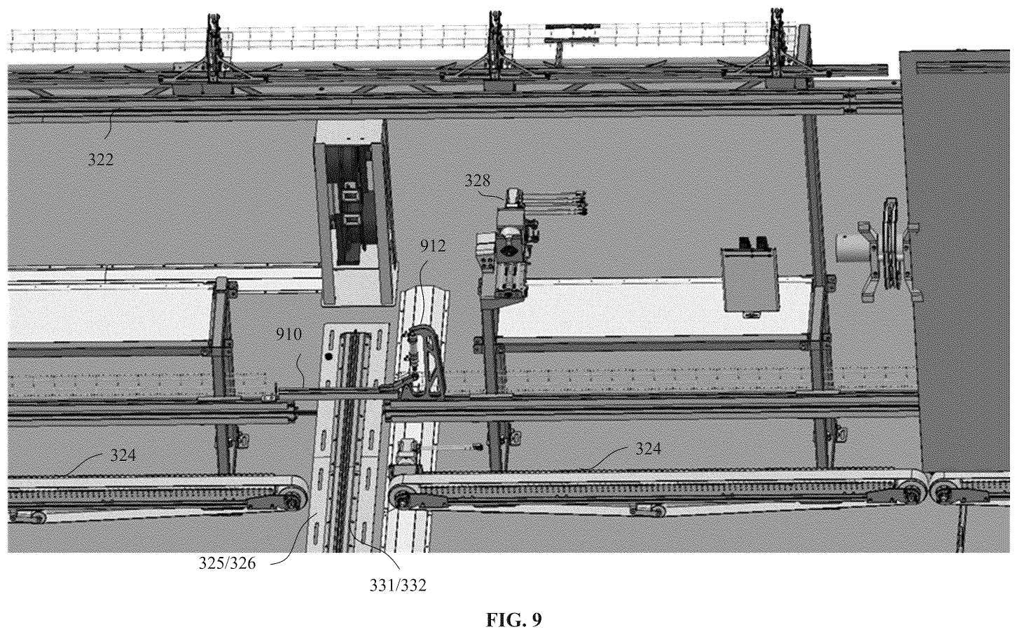

FIG. 9 is a close-up view of a lower rail in the table buffer section according to various embodiments of the present invention. A safety interlock 910 may be placed above the gap of the lower rail 324. The safety interlock 910 may be a bar configured to be closed during the transition of the solar table 312 from the assembly stage 310 to the table buffer section 320 and to be open to allow the off-loading lifts 333/334 to slide along the off-loading rails 331/332 to off-load the solar table 312 to a mobile transport vehicle. Additionally, when closed, the safety interlock 910 is used as a bridge to provide a continuous support surface for the fully assembled table to minimize the risk of the assembled table being caught or struck on the gaps.

Specifically, before the assembled solar table 312 is moved from the assembly stage 310 to the table buffer section 320, the safety interlock 910 needs to be open to allow the off-loading lifts 333/334 to slide to the start location (behind the table buffer section 320) of the off-loading rails 331/332. Afterward, the safety interlock 910 is closed to allow the table buffer section 320 to receive the solar table 312. Additionally, when closed, the safety interlock 910 is used as a bridge to provide a continuous support surface for the fully assembled table to minimize the risk of the assembled table being caught or struck on the gaps. The assembly stage 310 may be ready for subsequent solar table assembly immediately without needing to wait for the assembled solar table 312 to be picked up by a mobile transport vehicle. After the solar table 312 is fully received at the table buffer section 320, the off-loading lifts 333/334 hold the torque tube of the solar table 312. Subsequently, the safety interlock 910 is open again to block further solar table transition from the assembly stage 310 and to allow the off-loading lifts 333/334 with the solar table sliding along the off-loading rails 331/332 toward the table off-loading section 330 to off-load the table onto a mobile transport.

In one or more embodiments, the off-loading lifts 333/334 may first rotate the table and then proceed along the off-loading rails 331/332 to handoff the table 340 to the loading lifts 353/354. Afterwards, the off-loading lifts 333/334 may quickly return back to the starting position behind the table buffer section 320, ready to receive a subsequent assembled table.

In one or more embodiments, the safety interlock 910 may be a bar controlled by a linear actuator 912 through a hinge. When the linear actuator 912 extends, the safety interlock 910 is pivoted to an open position. When the linear actuator 912 retracts, the safety interlock 910 is lowered to a closed position. Although FIG. 9 shows an example embodiment of the safety interlock using a pivotable bar, one skilled in the art shall understand other means, such as a sliding bar, may also be applicable to safety interlock.

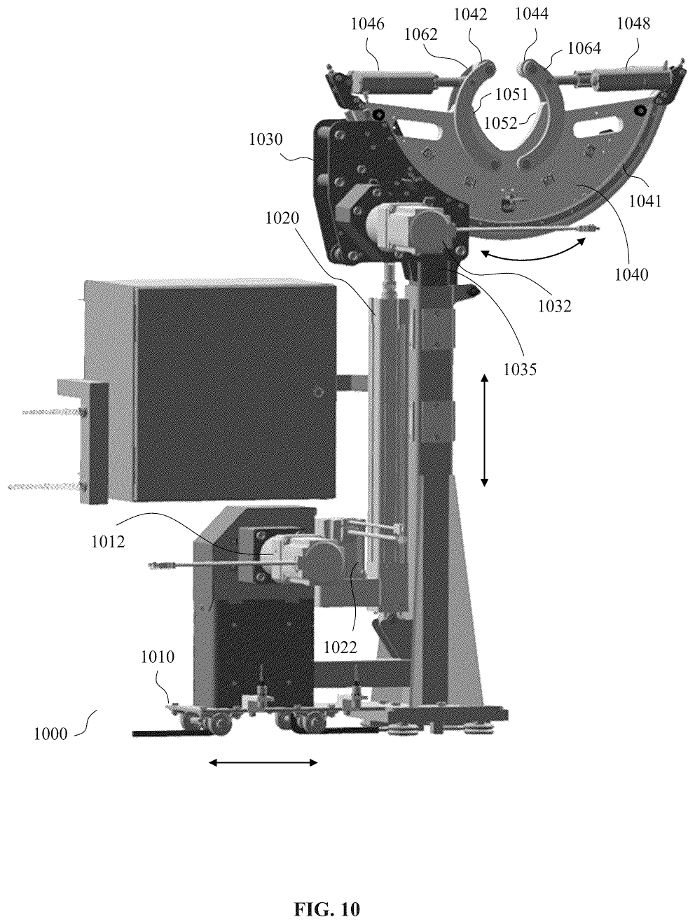

FIG. 10 depicts a standalone view of an off-loading lift according to various embodiments of the invention. The off-loading lift 1000 comprises a lift base 1010, a lift arm 1035, an actuator 1020, a holder base 1030, and a tube holder 1040. The lift base 1010 couples to a base motor 1012 for movement along the off-loading rails 331/332. The lift arm 1035 is moved up and down by the actuator 1020. The actuator 1020 sits on the lift base 1010 and is controlled by an actuator motor 1022 for vertical expansion/retraction of the lift arm to lift or lower the holder base 1030. The tube holder 1040 rotatably couples to the holder base 1030 via a curved rail 1041 that allows the tube holder 1040 to be rotated under the control of the rotation motor 1032 to different orientations. The tube holder 1040 further comprises a first curved arm 1062 and a second curved arm 1064, controlled by a first pivot actuator 1046 and a second pivot actuator 1048, respectively. The first curved arm 1062 comprises a first compression roller 1042 and the second curved arm 1064 comprises a second compression roller 1044. The compression rollers 1042 and 1044 have a round or convex shape to direct a clamping force into a normal force into the tube forcing the tube down into the concave clamping surfaces 1051 and 1052 in the tube holder. The clamping surfaces 1051 and 1052 are shaped to contact the torque tube at a near tangential angle, thus amplifying the downward force from the pivotable rollers and creating a large static frictional force between the clamping surfaces and the tube, to safely secure torque tube and table in any rotational position.

When the off-loading lift 1000 slides to a start location of the off-loading rails 331/332, the tube holder 1040 is rotated to face the torque tube and has the curved arms open such that the torque tube can be fitted cross-sectionally between the compression rollers. The curved arms 1062/1064 are then closed by the pivot actuator 1046/1048 to securely hold the torque tube. Afterward, the safety interlock 910 opens, the off-loading lift 1000 may slide along an off-loading rail toward the table off-loading section 330 to an off-loading location (e.g., an opposite end of the start location) for table off-loading. During the transition from the start position to the off-loading position the table might or might not be rotated.

When the off-loading lift 1000 starts sliding along the off-loading rail, the solar table is held in a buffering orientation (e.g., vertical or generally vertical), defined by the table buffer section 320. The off-loading lift 1000 may rotate the solar table to an off-load orientation (e.g., a horizontal orientation) after the off-loading lift 1000 slides to the off-loading location. Alternatively, the off-loading lift 1000 may perform table rotation parallel to sliding.

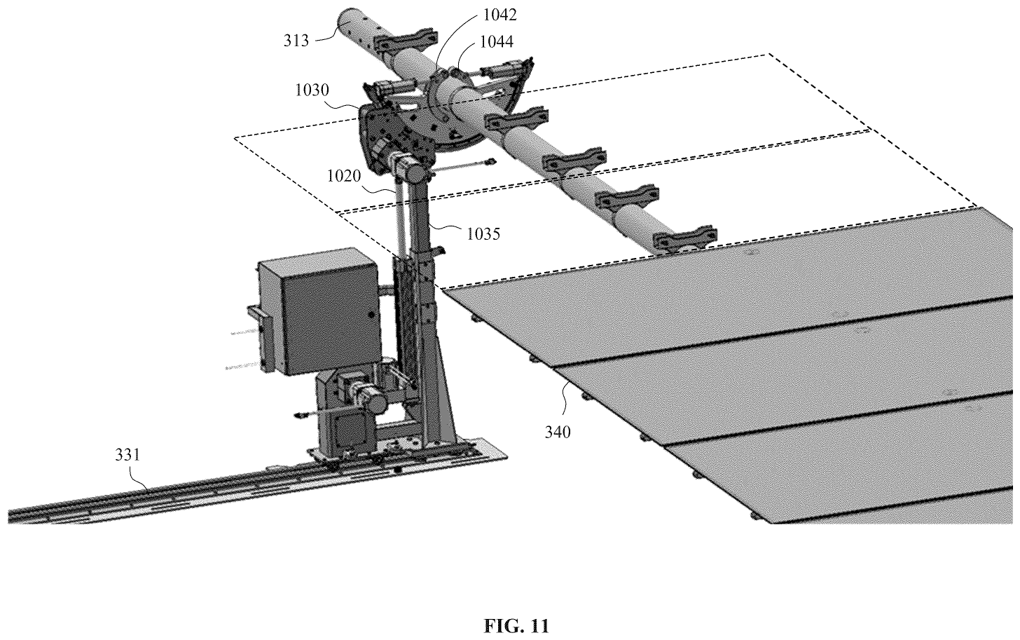

FIG. 11 depicts a perspective view of an off-loading lift with a solar table according to various embodiments of the invention. As shown in the figure, the solar table 340 is rotated into a horizontal orientation. For clarity of the figures, several solar panels and associated purlins of the solar table 340 are shown as transparent. The lift arm 1035 may be expanded to lift the solar table 340 to a desired height for table off-loading onto a mobile transport vehicle directly, or to the loading lifts 353/354 for additional table buffering. For example, with the solar table 340 lifted, the mobile transport vehicle (e.g., the motorized vehicle 210) may park between two off-loading lifts to receive the solar table conveniently. Once the solar table 340 is off-loaded onto the mobile transport vehicle, the pivotable rollers 1042/1044 may be opened, the lift arm 1020 may be lowered, and the off-loading lift 1000 may slide back to the start position of the start location of the off-loading rail 331 for subsequent operations.

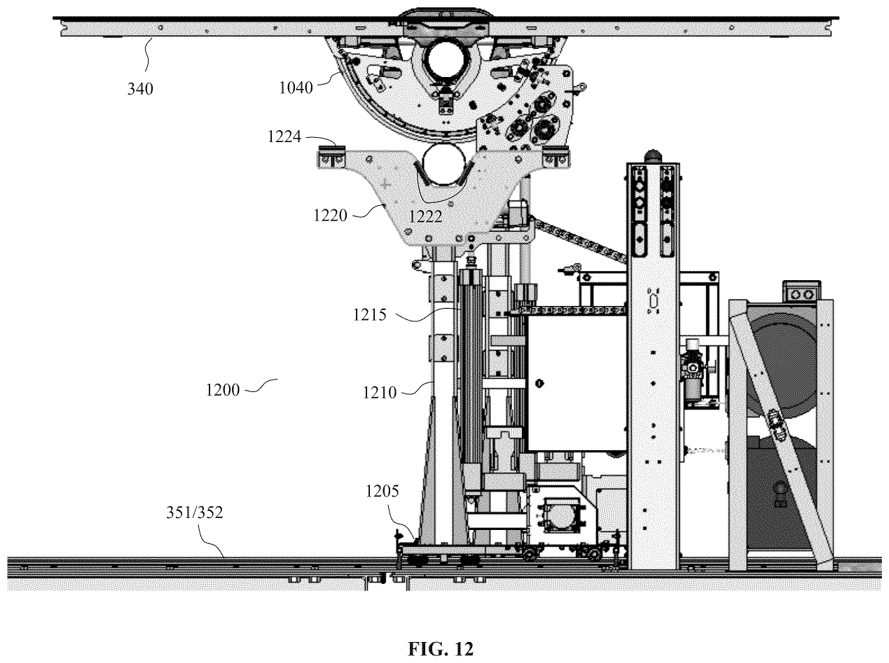

FIG. 12 depicts handoff of a solar table from off-loading lifts to loading lifts according to various embodiments of the invention. The loading lift 1200 comprises a base 1205, a loading lift arm 1210, an actuator arm 1215, and a loading clamp 1220. The base 1205 may move along the loading rails 351/352. The loading lift arm 1210 is moved up and down by the actuator arm 1215 to lift or lower the loading clamp 1220. The loading clamp 1220 comprises two contact surfaces 1222 shaped such that, once the solar table 340 is off-loaded on the holder 1220, the gravitational forces are amplified to create sufficient normal forces (and thus anti-rotational friction forces) to securely hold the table in place during the handoff process. The loading clamp 1220 may further comprise one or more anti-rotation pads 1224 for additional stabilization the solar table 340.

In one or more embodiment, to handoff the solar table from the off-loading lifts 333/334 to the loading lifts 353/354, the off-loading lifts move from the starting position behind the buffer structure through the two gaps to the end of the off-loading rail 331/332. During the movement to the end of the off-loading rails, the solar table 340 might be rotated to a horizontal position. At the end of the off-loading rails, the off-loading lifts position the solar table 340 above the loading clamp 1220 such that the torque tube may be loaded into the clamp 1220 as the loading lift 1200 extends vertically to engage the torque tube and lifts the table vertically out of the curved arms 1062/1064, which have been opened. When the loading lift 1200 moves the solar table above the off-loading lifts with clearance, the off-loading lifts move back behind the table buffer section with the tube holder 1040 rotated back to face toward the torque tube of a subsequent solar table finished assembling and moved from the assembly stage. The loading lifts may move to a final loading position when called to load the solar table onto a waiting transport vehicle. The call may be initiated by a transport vehicle driver by touching a button, or automatically by a transport vehicle control system or a factory control system when the transport vehicle has arrived at the final loading position.

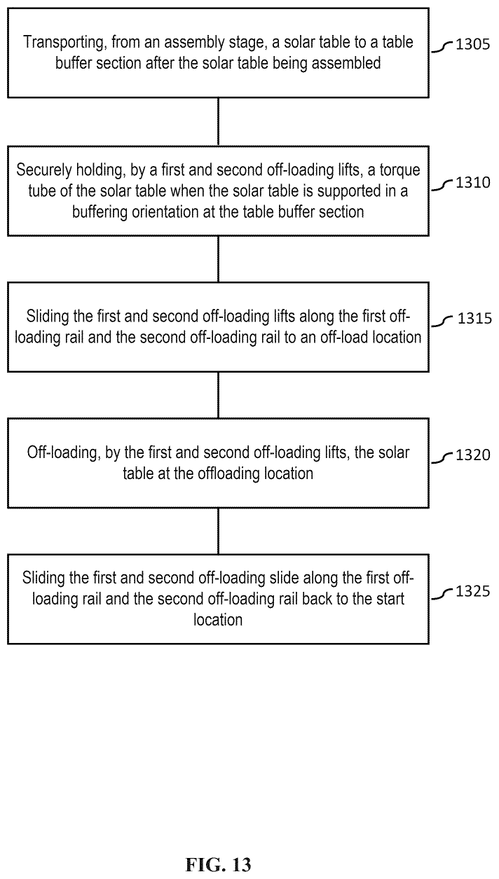

FIG. 13 is a process diagram of off-loading a solar table from an assembly stage according to various embodiments of the invention. In step 1305, a solar table is transported from an assembly stage to a table buffer section after the solar table is assembled. The table buffer section is an extra section of conveyance and support to allow assembled solar tables to move out of the assembly stage. The table buffer section comprises an upper rail extended from a top rail of the assembly stage and a lower rail extended from a bottom rail of the assembly stage. The lower rail has a first gap and a second gap to allow pathways for a first and second off-loading lifts sliding along the first off-loading rail and the second off-loading rail, respectively, to a start position for table picking up.

In step 1310, the first and second off-loading lifts securely hold the torque tube of the solar table when the solar table is supported in a buffering orientation at the table buffer section. In step 1315, the first and second off-loading lifts slide along the first off-loading rail and the second off-loading rail to an off-load location. The off-loading lifts may rotate the solar table to an off-load orientation after the off-loading lifts slide to the off-loading location or be rotated while the off-loading lifts slide. In step 1320, the first and second off-loading lifts off-load the solar table at the off-load location onto a mobile transport vehicle directly or onto a first and second loading lifts. In step 1325, the first and second off-loading slide along the first off-loading rail and the second off-loading rail back to the start location for subsequent table picking-up operations.

It will be appreciated by those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently, including having multiple dependencies, configurations, and combinations.

What is claimed is:

1. A system for solar table off-loading, the system comprising:
a table buffer section that receives a solar table from an assembly stage once the solar table is assembled, the solar table comprises a torque tube and multiple solar panels attached to the torque tube, the table buffer section comprising:
multiple rollers that are configured for transferring one or more torque tubes toward the assembly stage for solar table assembling;
an upper rail extended from the assembly stage; and
a lower rail extended from the assembly stage to support the solar table, the lower rail has a first gap and a second gap; and
a table off-loading section placed in front of the table buffer section, the table off-loading section comprising:
a first off-loading rail;
a second off-loading rail;
a first off-loading lift slidably coupled to the first off-loading rail and a second off-loading lift slidably coupled to the second off-loading rail, the first and second gaps allow pathways for the first and second off-loading lifts sliding across the first and the second gaps toward the table buffer section for holding the torque tube.

2. The system of claim 1 wherein the upper rail is a continuous rail.

3. The system of claim 1 wherein the multiple rollers are adjustable horizontally.

4. The system of claim 1 wherein the table buffer section further comprising:
a safety interlock placed above each of the first and second gaps of the lower rail, the safety interlock is configured to be closed during transition of the solar table from the assembly stage to the table buffer section and to be open to allow the first and second off-loading lifts sliding toward the table off-loading section.

5. The system of claim 4 wherein the safety interlock is a bar that is pivotable for opening or closing.

6. The system of claim 1 wherein each of the first and second off-loading rails comprising:
a lift base configured for sliding movement along one of the first and second off-loading rails;
a lift arm that sits on the lift base and is configured for vertical expansion or retraction;
a holder base that is lifted or lowered by the lift arm; and
a tube holder rotatably coupled to the holder base via a curved rail to allow the tube holder to be rotated to different orientations, the tube holder comprises a first curved arm and a second curved arm controlled by a first pivot actuator and a second pivot actuator, respectively, the first curved arm comprises a first compression roller and the second curved arm comprises a second compression roller.

7. The system of claim 6 wherein the first and second compression rollers direct a clamping force into a normal force into the torque tube forcing the torque tube down into concave clamping surfaces in the tube holder.

8. The system of claim 6 wherein the tube holder faces the torque tube and has the first and second curved arms open such that the torque tube is fitted cross-sectionally between the first and second curved arms.

9. The system of claim 8 wherein the solar table is in a buffering orientation supported by the table buffer section when the first and the second off-loading lifts hold the torque tube of the solar table.

10. The system of claim 8 wherein the solar table is rotated to an off-loading orientation during the first and the second off-loading lifts moving to an off-loading location.

11. A method of solar table buffering and off-loading, the method comprising:
receiving, at a table buffer section, a solar table from an assembly stage after the solar table being assembled, the solar table comprises a torque tube and multiple solar panels attached to the torque tube, the table buffer section comprises multiple rollers that are configured for transferring one or more torque tubes toward the assembly stage for solar table assembling;
securely holding, by a first off-loading lifts and second off-loading lift, the torque tube of the solar table when the solar table is supported in a buffering orientation at the table buffer section;
sliding the first and second off-loading lifts slide along a first off-loading rail and a second off-loading rail to an off-load location for table off-loading.

12. The method of claim 11 wherein the table buffer section comprising:
multiple rollers spaced and aligned for supporting the torque tube;
an upper rail extended from the assembly stage; and
a lower rail extended from the assembly stage, the lower rail has a first gap and a second gap.

13. The method of claim 12 wherein the first and second gaps allow pathways for the first and second off-loading lifts sliding across the first and the second gaps toward the table buffer section for holding the torque tube.

14. The method of claim 12 wherein each of the first gap and the second gap has a safety interlock placed above, the safety interlock is configured to be closed during transition of the solar table from the assembly stage to the table buffer section and to be open to allow the first and second off-loading lifts sliding across.

15. The method of claim 14 wherein the safety interlock is a bar that is pivotable for opening or closing.

16. The method of claim 11 wherein each of the first and second off-loading rails comprising:
a lift base configured for sliding movement along one of the first and second off-loading rails;
a lift arm that sits on the lift base and is configured for vertical expansion or retraction;
a holder base that is lifted or lowered by the lift arm; and
a tube holder rotatably coupled to the holder base via a curved rail to allow the tube holder to be rotated to different orientations, the tube holder comprises a first curved arm and a second curved arm controlled by a first pivot actuator and a second pivot actuator, respectively, the first curved arm comprises a first compression roller and the second curved arm comprises a second compression roller.

17. The method of claim 16 wherein the first and second compression rollers direct a clamping force into a normal force into the torque tube forcing the torque tube down into concave clamping surfaces in the tube holder.

18. The method of claim 16 wherein the tube holder faces the torque tube and has the first and second curved arms open such that the torque tube is fitted cross-sectionally between the first and second curved arms.

19. The method of claim 16 further comprising:
rotating the solar table to an off-loading orientation after the first and second off-loading lifts slide to the off-load location or during the sliding of the first and second off-loading lifts slide to the off-load location.

20. The method of claim 19 further comprising:
sliding the first and second off-loading lifts back to the table buffer section for subsequent operations after off-loading the solar table.
